(19) United States
(12) Patent Application Publication
(10) Pub. No.: US 2007/0250423 A1
(43) Pub. Date: Oct. 25, 2007

(54) METHOD AND SYSTEM FOR THE ESTABLISHMENT OF FINANCIAL MODELS FOR GOAL-ORIENTED ORGANIZATIONS

(76) Inventors: Emrich M. Stellar JR., Center Valley, PA (US); Montel R. Hill, Clarksville, MD (US)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 11/691,841

(22) Filed: Mar. 27, 2007

Related U.S. Application Data
(60) Provisional application No. 60/786,229, filed on Mar. 27, 2006.

(51) Int. Cl. G06Q 40/00

(52) U.S. Cl. 705/35

(57) ABSTRACT

A system and method for the establishment of a financial model that enables an organization to achieve its goals. Preferably the model is designed to provide an organization with a sufficient endowment and financial plan that will enable continued obtainment of goals. Additionally, the financial model should provide the organization with the ability to obtain institutional quality loans in order to further achieve its goals.

This application claims benefit of U.S. Provisional Application No. 60/786,229 filed on Mar. 27, 2006, the entirety of which is incorporated herein by reference.

### BACKGROUND OF THE INVENTION

1. Field of Invention

The invention relates to the field of financial investment. In particular, the invention relates to the application of financial strategies to non-profit goal-oriented organizations.

2. Description of the Related Technology

Charitable organizations have operated using the same principles for many years. The social capital market lacks cohesion, operating efficiency and a formal capital structure to sustain its collective charity in perpetuity. Among the major systemic problems of American society today that illustrate a growing failure of social capital markets is the ineffectiveness of public schools, high cost of healthcare, crime and unemployment.

The federal government has sustained social capital markets in the past. However, as former President George H. W. Bush stated in 1989 “the old solution, the old way, was to think that public money alone could end these problems. But we have learned that is not so. And in any case, our funds are low. We have a deficit to bring down. We have more will than wallet.” Consistent with the former President's comments, currently, federal programs of interest to non-profit organizations—groups that often serve as the backbone of communities in times of crisis—will be cut between $ 40 billion and $ 71.5 billion over the next five years, according to an analysis of a recent presidential and congressional budget proposals. Failure of government sponsored programs to provide adequate maintenance of public programs will compel charitable organizations and non-profit organizations to assist those in need.

Over the past ten years academic scholars and philanthropists have unsuccessfully attempted to resolve the inefficiencies of the social capital market. The failure of government, academia and the philanthropic community clearly demonstrates that reform of the social capital market cannot be sustained solely through changes to legislation, corporate policies and/or practices. “We are now entering a new era of human communication based on digital communications. The financial services industry will become the dominate player in the development of global society over the next one hundred years.” Increasingly there is a demand for non-government supported organizations to provide a charitable function.

Currently, there are no financial models that enable a goal-oriented organization to establish and adequately sustain charitable functions. Additionally, there are no financial models that facilitate the achievement of investment grade financing that would further assist and enable charitable giving.

Therefore there is the need for a method and system for enabling goal-oriented organizations to sustain charitable functions and establish the ability to achieve investment grade financing.

### SUMMARY OF THE INVENTION

The present invention provides a method and system for enabling goal-oriented organizations to sustain charitable functions and establish the ability to achieve investment grade financing.

In a first aspect of the invention, a method for establishing a comprehensive financial plan is disclosed. The plan has the steps of: (a) evaluating the financial status of a goal-oriented organization; (b) providing a long term financial plan based upon the step of evaluating; (c) insuring a pool of individuals who are donors to said goal-oriented organization; (d) providing an investment strategy for donations; (e) establishing a predetermined allotment of donated money; (f) combining steps (a)-(e) to form a comprehensive financial plan.

In a second aspect of the invention, a system for establishing a comprehensive financial plan having a computer for executing a software program is disclosed. The software program has means for evaluating the financial outlook of a goal-oriented organization, means for providing a long term financial plan based upon the evaluation, means for providing a pool of individuals who are donors money to the goal-oriented organization and insuring said pool of individuals, means for providing an investment strategy for donations, establishing a predetermined allotment of donated money and formulating a comprehensive financial plan.

In a third aspect of the invention, a method for providing a financial plan is disclosed. The plan has the steps of (a) providing a long term plan for a goal-oriented organization, (b) providing a pool of individuals who are donors to the goal-oriented organization and insuring the pool of individuals, (c) establishing a plan for receiving and managing donations, (d) providing a plan for obtaining an endowment; and (e) providing a financial plan incorporating steps (a)-(e).

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described preferred embodiments of the invention.

### BRIEF DESCRIPTION OF THE DRAWING(S)

FIG. 1 is a flow chart showing the method for establishing a long term plan.

FIG. 2 is a flow chart showing the method for establishing donor capital maximization.

FIG. 3 is flow chart showing the method for the provision of a structured giving plan.

FIG. 4 is a flow chart showing the establishment of an institutional money fund.

FIG. 5 is flow chart showing the establishment of a structured financing plan.

### DETAILED DESCRIPTION OF THE INVENTION

The instant invention integrates a variety of fiscal and financial strategies that preferably involves up to five fiscal and financial planning strategies. These fiscal and financial strategies are designed to provide long-term capital solutions for churches and other nonprofit organizations, such as groups benefiting animal, arts, culture, humanities, education, environment, health, human services, international, public benefit, region. The various strategies include; long term planning; donor capital maximization; structured giving; endowment capturing; and structured financing.

The premise underlying the design of structured capital financial plans is that the social capital market lacks cohesion and a formal capital structure to sustain its collective charity in perpetuity. The organizations that form the “social capital market” are those organizations that are typically “non-profit” that receive a majority of their funding via charitable donations and whose primary business is that of public assistance and/or cause oriented goals. Part of the problem is that the largest players in the social capital market, which are churches, lack strategic direction, connectivity within the social capital market and capital efficiency. One of the aspects of the present invention is to provide innovative financial solutions to solve the problems that are endemic with those organizations that form part of the social capital market. Another aspect of the present invention is to provide an additional source of revenue for those organizations that are primarily dependent upon charitable donations.

The method and system provides a structured capital solution that involves endowment building and long term borrowing that is linked to specific charity initiatives (e.g. human services, education, healthcare or other under-funded segments of the social capital market). For example, the typical transaction may involve a plan to build a minimum of $100 million of endowment assets. In order for nonprofits to access “capital efficient” (i.e. long-term, low-cost debt) long-term borrowings they should allocate a preferred minimum of 50% or more of total endowment spending to charity and maintain a minimum level of investment assets. However, it should be known that a minimum of 40% could be used.

Providing structured capital financial provides money management solutions for, goal-oriented organizations such as churches and other non-profit organizations. Structured capital financial plans are also capable of changing the existing platform of goal-oriented organizational leading from an asset based commercial real estate loan that results in a non-earning asset to a “structured capital finance” model that results in a return on investment (i.e. an earning asset), capital efficiency and preferably a minimum of a $100 million dollar endowment fund.

Part of the fiscal planning is to provide a core formula to be employed for facilitating the acquisition of long term investment grade debt. Investment grade is a direct reference to the quality of a company's credit. In order to be considered an investment grade issue, the company must be rated at “BBB” or higher by Standard and Poor's or Moody's. Anything below this “BBB” rating is considered junk grade, and the probability of the company repaying its issued debt is deemed speculative. Investment grade debt can be a bond that is rated BAA, A, or BBB (for S & P rated bonds). For stocks, investment grade debt can be, a firm that has a strong balance sheet and considerable capitalization.

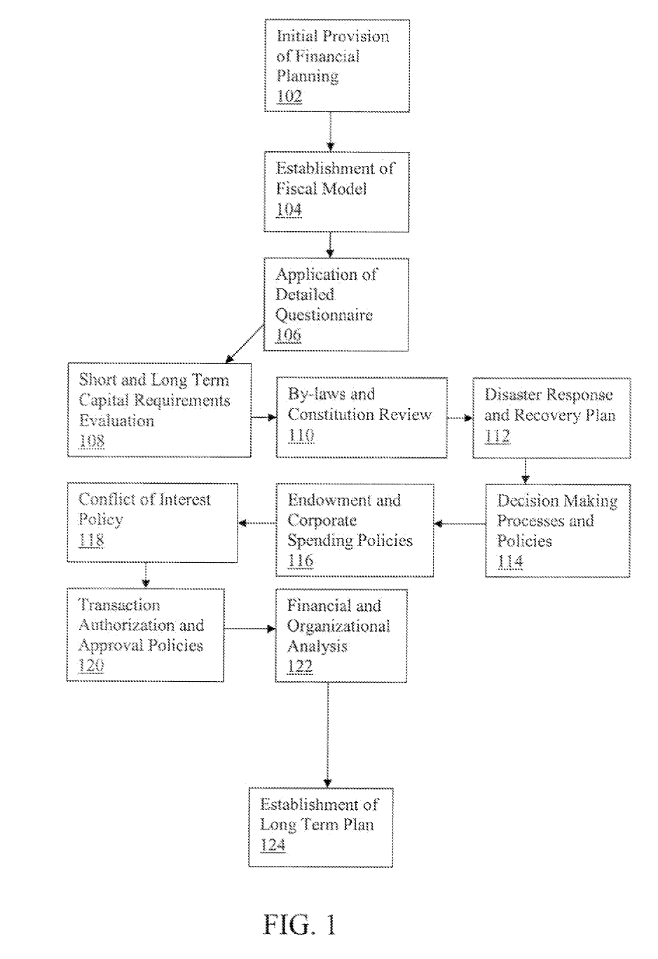

The first part of the method is to establish a long term plan to establish a basis in which to plan a goal-oriented organization's finances. The method for establishing a long term plan is shown in FIG. 1. The basis for the formula employed takes the annual total core revenue and multiplies that by the capitalization rate (e.g. 30%). The result of this initial formula provides a base for long term planning.

Establishment of the long term plan is the foundation of the structured capital plan. It affects the amount of short and long-term borrowing. It also affects the growth rate and ultimate size of an endowment fund. The basic premise underlying establishing a long term plan is that like most small businesses many non-profit goal-oriented organizations are substantially undercapitalized or under funded. Long term planning imposes responsibility on organizers and/or fiduciaries to structure and maintain a fiscal formula(s) to sustain the mission of their organizations (i.e. capitalize or “fund the vision”).

Establishment of a long term plan involves a decision-making process whereby fiduciaries or managers of a goal-oriented organization make an election to utilize a fiscal operating structure whereby a stipulated percentage of every dollar collected is allocated to fund long-term needs. The various factors of the underlying decision making process can be made via the usage computer system or network.

Capitalization rates may range from 5%-50%. Preferred capitalization rates range from 15% to 30%. A preferred operating structure has a non-profit organization allocate seventy percent (70%) of every dollar collected to its current operating requirements (i.e. annual expenses) and the remaining thirty percent (30%) to its long-term charitable or goal-oriented needs.

For example, a church that generates $ 10,000,000 annually would be required and/or the 70/30 operating structure to operate its ministry on 70% or $ 7 million per year and deposit into an investment brokerage account 30%, an annual minimum of $ 3 million is used to build an endowment fund and service the interest costs on organization owned life insurance, sometimes referred to as corporate owned life insurance (COLI) and long-term debt over a thirty year endowment period. The endowment period may vary depending upon the need of the specific organization. A non-profit organization must elect a capitalization rate and satisfy other key fiscal requirements in order to fully utilize a structured capital solution. A fiscal planning questionnaire is used to assess the long term capital requirements and understand the organizational structure and corporate governance of client nonprofits.

Many middle-market non-profit organizations, such as independent protestant churches, do not currently utilize fiscal techniques in the management of their operations. These organizations frequently operate haphazardly and lack the franchise or institutional value of profit oriented institutions. Long term planning can be utilized to build institutional value and deliver fiscal reform and structure to non-profit and goal-oriented organizations.

FIG. 1 shows a flow chart depicting the method for establishing a long term plan. At step 102 the initial provision of the financial planning is provided. This provides a basic preliminary financial plan or an overview upon which to base a more detailed long term plan. At step 104, an initial fiscal model is established. At step 106, the goal-oriented organization is provided with a questionnaire to help establish the overall structure of the organization. An organization would work to provide as much financial detail as possible regarding the organization. The provision of the questionnaire may be provided on a network or provided as part of a software program.

It should be understood that the implementation of the methods described herein may be performed through the usage of analytical software programs and computer implemented processes the details of which do not need to be described herein and that would be evident to those of skill in the art. The steps shown in FIGS. 1-5 and described below may be configured to be automatically implemented on a computer or a computer network and the various means discussed herein performed using a processor or processors of a computer system and/or network.

Referring back to FIG. 1, steps 108-120 illustrate potential criteria that can be used in evaluating the financial status of an organization. These steps need not be performed in the order shown and more or less criteria can be used. However, it is preferable that more rather than less be used in order to develop a complete picture of the financial status of the organization. Step 108 involves the evaluation of the short and long term capital requirements of an organization. Step 110 involves establishing and/or reviewing the by-laws and constitution of an organization. Step 112 involves establishing and/or reviewing disaster response and recovery plans. Step 114 involves establishing and/or reviewing decision making processes and policies. Step 116 involves establishing and/or reviewing endowment and corporate spending policies. Step 118 involves establishing and/or reviewing policies related to conflicts of interest. Step 120 involves establishing and/or reviewing transaction authorization and approval policies. Step 122 involves the analysis of the financial situation and the organization based upon the information provided in the questionnaire. At step 124, this information is used to establish a long term plan for the usage of finances for the organization. This is one factor used in the establishment of a comprehensive structured financing plan.

Another aspect of the invention is the usage of donor capital maximization (DCM). Donor capital maximization takes general and elite donor organizational owned life insurance (OOLI) pools plus the reload pools and adds it to the structured giving plan (discussed below) in order to provide donor capital maximization. In a general donor strategy, lower net worth members having less net worth, disposable income and lower excess insurable capacity are part of a general donor pools consisting of 25 to 200 donors that would be part of a guaranteed issue COLI plan as a leverage tool. Smaller elite donors groups with higher net worth, more discretionary income and typically higher insurable capacity limits will use a variety of funding techniques to support the general donor pools and elite strategies including private placement annuity, and a variety of IRS sanctioned planning techniques, which are well known in the art.

Donor capital maximization represents a unique strategy designed to leverage distinctive donor pools (i.e. general and elite donors) within a non-profit organization to build capital resources using OOLI. Although insurance companies have no real history of marketing COLI to the social capital market, it is believed that funding charity is a preferred usage of OOLI. Nonprofits and goal-oriented organizations represent a major market opportunity for this particular insurance instrument.

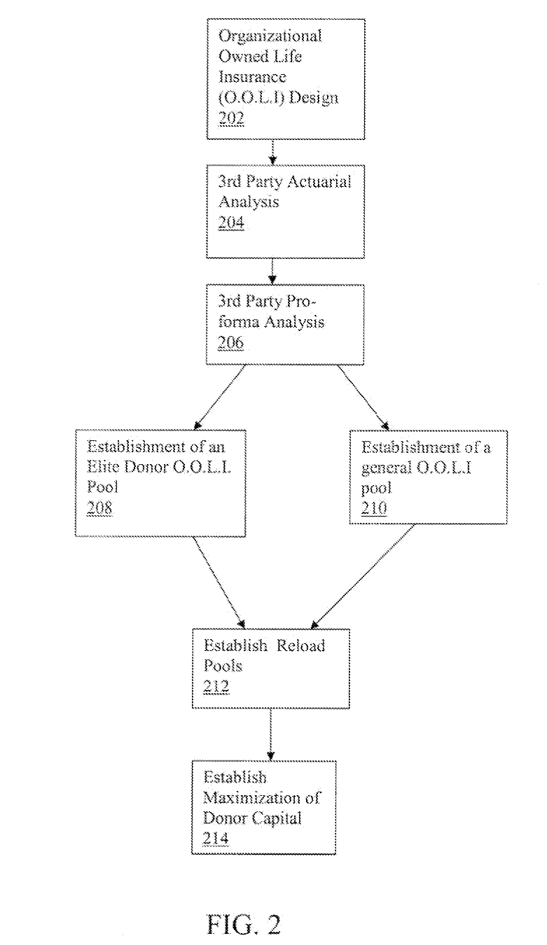

The instant invention utilizes these insurance instruments to build endowment funds for the purpose of funding a non-profit organization's long-term charity. Organizations such as independent Protestant churches, as well as many other nonprofits receive over 95% of their support from individual donors who represent their lifeline. These donors voluntarily contribute up to 10% or more of their total annual compensation to their church and may also be willing to donate a portion of their insurable capacity. Once every seven to twenty-five years (depending on growth) another re-pooling of 25-200 donors is utilized for a new OOLI transaction. This new pool of human capital (replenished every 7-25 years), or as growth revenue dictates, is shown in FIG. 2 as the “reload pool”. The combination of general, elite and reload pools along with structured giving discussed elsewhere can effectively create a well financed organization.

For example, a typical DCM transaction may involve a nonprofit purchasing approximately $ 20 million of OOLI on two hundred general donors/fiduciaries between the ages of 40 and 70. The premium for the $ 20 million OOLI policy would typically cost $ 5 million and would be financed separately. Additionally, utilizing the capital of elite donors (i.e. donors with high net worth, large contributors, high available insurable capacity) or general donors, nonprofits may enter into another OOLI transaction that leverages via traditional “premium financing” or lending from elite donors or foundation an elite donor pool or another general pool. Alternatively, elite donor capital may also be used to expand the original general donor pool. These strategies are reloaded periodically, as noted above. Each and every DCM pool is actuarially evaluated by a 3rd party actuary to assess mortality and likely cash flow of insurance proceeds. Actuary reports are used to support the premium and real estate financing arrangements.

FIG. 2 shows the steps involved in establishing the maximization of donor capital. In step 202, the organizational owed life insurance instrument is designed for the specific organization involved. In step 204, a third party actuarial analysis is performed on a group of selected individuals. In step 206, a pro-forma analysis is performed on the group of selected individuals. Typically, these individuals are constant donors or contributors to the goal-oriented organization. It is to be understood that a donor may be an individual who donates either money, time or social capital to the goal-oriented organization. The group of individuals may be sub-divided into elite and general donors. Elite donors may be those donors who contribute over a certain amount of money or time to the fund. The remaining group of donors may be considered general donors. At step 208 the elite donors are used to establish organizational owned life insurance policies. At step 210 the general donors are used to establish more organizational owned life insurance policies. At step 212, reload pools for the various groups of individuals are created in order to provide a continuous pool of insured individuals who provide donations to the goal-oriented organization. At step 214, the various policies and pools are instituted in order establish a maximization of donor capital for the goal-oriented organization.

The steps utilized to provide DCM may be planned and executed on a computer network and system. DCM may be part of the overall software package that is used in creating the structured financing plan.

Another strategy that is incorporated into the overall structure for goal-oriented organizations is structured giving. “Structured giving” is a term used to describe organizing functions in order to maximize charitable contributions and donations. Structured giving may involve a 3-5 year endowment fund raising pledge campaign, large donor strategies (e.g. charitable remainder and lead trusts), and general donor strategies, and reload campaigns. Structured giving is a concept that builds on an organization's ability to achieve goals. Charitable campaigns are designed to leverage a goal-oriented organization's ability to raise cash donations through systematic pledge campaigns and maximize its use of human capital by raising additional funds through unique, large and general donor strategies and reload campaigns. Endowment fund raising campaigns may be structured over a three to five year period based on the underlying theme of successfully implementing the long-term vision of a particular organization.

For example one objective may be to raise a sufficient amount of capital through fund raising to cover 100% of the OOLI premium and 50% of proposed structured finance. Another objective may be to structure their tithes and offerings to adhere to the fiscal model adopted by their charity re: long term planning. In essence, donors would contribute a portion of their charitable gifts to current operations and the remainder to the endowment fund.

Structured giving also integrates charitable gifting strategies such as charitable remainder trusts, charitable lead trusts, charitable gift annuities, pooled income funds and life insurance gifts. Structured giving is designed to maximize the fund raising ability of nonprofits to facilitate endowment growth and ultimately the accomplishment of a goal-oriented organization's vision. Another goal of these financial structures is the establishment of self-perpetuating goal-oriented organizations that can qualify for institutional lending rates.

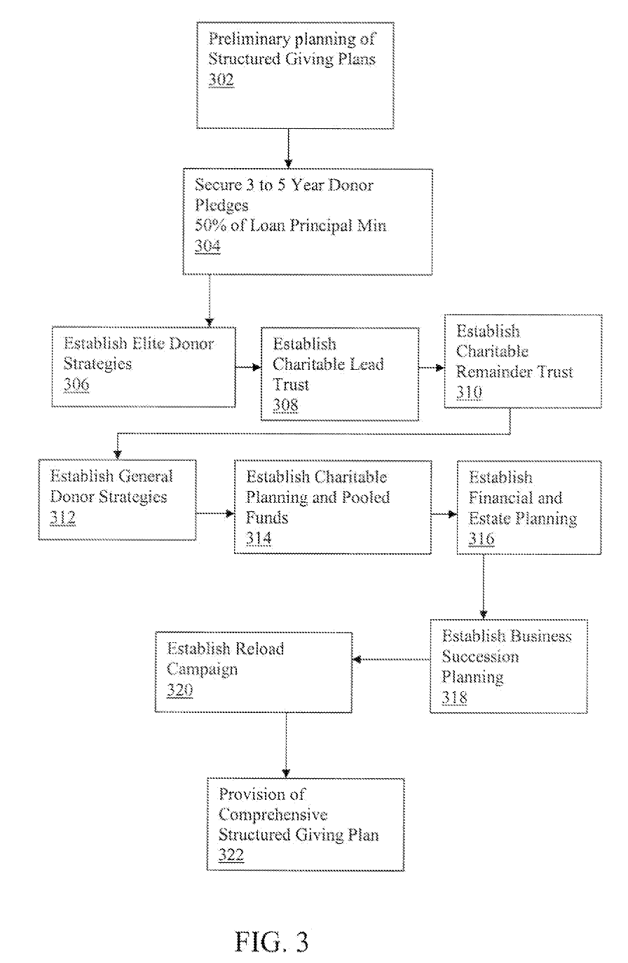

FIG. 3 shows the steps involved in establishing a comprehensive structured giving plan. At step 302 the initial planning of the structured giving plan is performed. This initial planning may involve using those factors needed to achieve the establishment of the long term plan and the establishment of maximization of donor capital. Steps 304-320 provide those steps that may be used to provide a comprehensive structured giving plan. Not all of the steps need to be undertaken in order to provide a complete plan, nor be performed in any particular order. Furthermore, additional steps may be provided in order to further provide a structured giving plan.

Still referring to FIG. 3, step 304, involves securing pledges for a 3 to 5 year donor drive. Preferably, the pledges in a drive of this nature should amount to roughly 50% of the load principal minimum. At step 306 elite donor strategies are created in order to effectively capture donations from those considered elite donors. At step 308, charitable lead trusts may be established. At step 310, charitable remainder trusts may be established. At step 312, general donor strategies are created in order to effectively capture donations from those considered elite donors. At step 314, charitable planning is performed and pooled funds are established. At step 316, financial and estate planning is performed. At step 318, business succession planning is established. At step 320, a reload campaign is planned. The reload campaign is for the pool of individuals discussed above with respect to the DCM. Together steps 304-320 are used to create and establish a comprehensive structured giving plan.

Endowment capturing involves using goal-oriented capital, structured giving, and financial planning from the long term plan. It is based on the premise of doing more with the money that is received via donations.

Preferably proceeds received via structured giving and long term planning should be managed by elite institutional money managers and venture capitalists. The targeted total return (i.e. 30 year planned endowment portfolio value less structured financing, total long term planning and structured giving contributed to the endowment fund) is preferably 100%. The annualized return is targeted at greater than 4%. A preferred annualized return is greater than 8%.

An example of a portfolio is provided below in table 1:

TABLE 1

| | |
|---|---|
| Domestic equities | 10%-20% |
| Foreign equities | 5%-15% |
| Emerging equities | 0%-10% |
| Private investments | 8%-18% |
| Absolute return | 9%-19% |
| Real Estate | 15%-25% |
| Commodities | 0%-10% |
| Fixed Income | 5%-15% |
| Cash | 0%-10% |

Investment strategies may vary depending upon the strength of the various markets. The aforementioned steps may be performed utilizing a computer program or networking system.

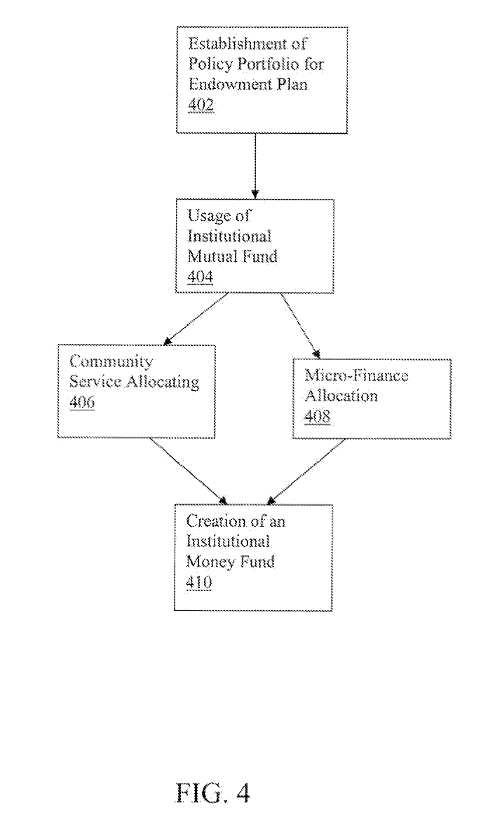

FIG. 4 discusses the steps involved in capturing an endowment. At stem 402, establishment of a policy portfolio that can be used with the donated money is performed. At step 404, the donated money is placed in institutional mutual funds. At steps 406 and 408, the donated money may be used for community investor advised services and for micro-finance allocation. At step 410, the steps are used for the creation of an institutional money fund used for maintaining the endowment.

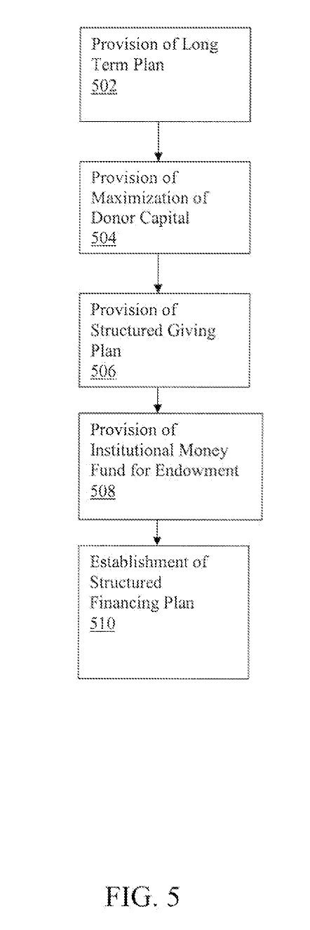

The above investment components may be combined to provide structured financing (SF). FIG. 5 illustrates the combination of the various components in order to provide structured financing. Step 502 is the provision of the long term plan. At step 504, the maximization of donor capital is established. At step 506, a structured giving plan is established. At step 508, endowment capturing is planned for and provided through the usage of institutional money funds. At step 510, the above components are used to provide structured financing and preferably the obtainment of discounted loan financing. Together these steps can be accomplished via a software program on a computer or provided over a network. In one embodiment, a system may be provided that can execute a financial model that will help a goal-oriented organization establish the financial stability to achieve structured financing.

The basic premise of structured financing is that loan finance solutions may be easily structured around the flow and value of long term planning, DCM, SG and endowment capturing. Conventional commercial mortgages are underwritten primarily based on the value of real estate and sufficiency of debt-service coverage ratios. Alternatively, the underwriting of SF transactions is based primarily on the analyzed financial strength of the enterprise (i.e. fiscal structure and management). The primary collateral is the cash and investments in the endowment account (i.e. long term planning+SG+beginning balance and earnings). Therefore, it is preferable to obtain investment grade financing.

A goal-oriented organization preferably funds their endowment account with an annual minimum long term planning rate of thirty percent (30%) and maintains a minimum level of cash in the investment account at all times. The minimum cash that should be available to service inverted yield curves and other temporary economic conditions or changes in management is ten percent (10%) to twenty percent (20%) of total SF.

SF is designed to never exceed a multiple of seven to ten times long term planning or three times gross revenue. SF is automatically paid down to recognize permanent declines in a goal-oriented annual long term planning funding. Principal pay-downs are facilitated through investment/endowment account. Temporary declines related to external market conditions do not result in principal pay-downs. Deficiencies in long term planning funding due to temporary economic conditions are serviced through the beginning balance of the investment account. A key factor that drives SF solutions is the risk management techniques that are utilized to build sufficient loan loss reserves to mitigate the overall credit risks of SF transactions to institutional investors. Permanent changes in long term planning funding due to economic or management related issues are provided for via the loan loss reserve estimated to approximate 1-2% of SF principle.

The loan loss reserve may be funded through a money manager's allocation of ten percent (10%) of all revenue generated to a fixed income fund that will collateralize all loan financing activity. Additionally, subordinated debt placements from financial services-institutional investors further reduces risks.

SF solutions are designed as an alternative to traditional debt/equity placements for institutional investors and may be delivered through a real estate loan conduit or institutional mutual fund. SF is designed to offer charities and other appropriate goal-oriented organizations an alternative to traditional mortgage financing which is priced higher than SF and is difficult to obtain. The primary difficulty is that commercial lenders have historically applied “asset based” underwriting criteria will substantial equity investment requirements (typically 30-40%) to church and nonprofit loan transactions.

SF transactions may be priced based on the floating thirty year treasury rate plus one hundred and fifty basis points or other long term fixed income index. Load fees can be between 100-300 basis points. The pricing for each individual transaction will be risk sensitive, and based on the customer credit rating, loan-to-value ratio, debt service coverage ratio and other pertinent data.

Together, the components discussed above can help establish a financially secure goal-oriented organization. This can enable such an organization to provide charitable services with greater ease.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A method for establishing a comprehensive financial plan comprising the steps of:
(a) evaluating the financial status of a goal-oriented organization;
(b) providing a long term financial plan based upon the step of evaluating;
(c) insuring a pool of individuals who are donors to said goal-oriented organization;
(d) providing an investment strategy for donations;
(e) establishing a predetermined allotment of donated money;
(f) combining steps (a)-(e) to form a comprehensive financial plan.

2. The method of claim 1, wherein a return of the investment strategy is designed to produce a return that is greater than an annualized return of eight percent.

3. The method of claim 1, wherein said comprehensive financial plan is used to obtain investment grade financing.

4. The method of claim 3, wherein the investment grade financing is obtained using bonds rated BBB or higher.

5. The method of claim 1, wherein the goal oriented organization is a religious organization.

6. The method of claim 1, wherein the step of evaluation further comprises the steps of taking the annual total core revenue of the goal-oriented organization and multiplying the annual total core revenue by a capitalization rate.

7. The method of claim 6, wherein the capitalization rate is between 15.0% to 30.0%.

8. The method of claim 1, wherein the step of evaluation comprises reviewing criteria selected from the group consisting of by-laws and constitution of an organization; disaster response and recovery plans; decision making processes and policies; endowment and corporate spending policies; policies related to conflicts of interest and transaction authorization and approval policies.

9. The method of claim 1, wherein the step of insuring the pool of investors further comprises donor capital maximization, wherein donor capital maximization comprises performing actuarial analysis of the pool of investors, and sub-dividing the pool of investors into an elite donor pool and a general donor pool.

10. The method of claim 9, further comprising establishing reload pools for the elite donor pool and the general donor pool.

11. A system for establishing a comprehensive financial plan comprising:
a computer for executing a software program;
the software program comprising;
means for evaluating the financial outlook of a goal-oriented organization;
means for providing a long term financial plan based upon said evaluation;
means for providing a pool of individuals who are donors to said goal-oriented organization and insuring said pool of individuals;
means for providing an investment strategy for donations;
establishing a predetermined allotment of donated money; and
formulating a comprehensive financial plan.

12. The system of claim 11, wherein the means for providing an investment strategy provides a return that is greater than an annualized return of eight percent.

13. The system of claim 11, wherein said comprehensive financial plan is used to obtain investment grade financing.

14. The system of claim 13, wherein the investment grade financing is obtained using bonds rated BBB or higher.

15. The system of claim 11, wherein the means for providing a pool of individuals who donate money to said goal-oriented organization and insuring said pool of individuals further comprises means for donor capital maximization, wherein the means for donor capital maximization comprises means for performing actuarial analysis of the pool of investors, means for sub-dividing the pool of investors into an elite donor pool and a general donor pool and means for establishing reloading of the elite donor pool and the general donor pool.

16. The system of claim 11, wherein the means for evaluating comprises taking the annual total core revenue of the goal-oriented organization and multiplying the annual total core revenue by a capitalization rate, wherein the capitalization rate is between 15.0% to 30.0%.

17. The system of claim 11, wherein the means for evaluating comprises analyzing data selected from the group consisting of by-laws and constitution of an organization; disaster response and recovery plans; decision making processes and policies; endowment and corporate spending policies; policies related to conflicts of interest and transaction authorization and approval policies.

18. A method for providing a financial plan comprising the steps:
(a) providing a long term plan for a goal-oriented organization;
(b) providing a pool of individuals who are donors to said goal-oriented organization and insuring said pool of individuals;
(c) establishing a plan for receiving and managing donations;
(d) providing a plan for obtaining an endowment; and
(e) providing a financial plan incorporating steps (a)-(e).

19. The method of claim 18, further comprising the step of obtaining investment grade financing using the results of step (e).

20. The method of claim 18, wherein step (b) further comprises donor capital maximization, wherein donor capital maximization comprises performing actuarial analysis of the pool of investors, and sub-dividing the pool of investors into an elite donor pool and a general donor pool.
